(19) United States
(12) Patent Application Publication
(10) Pub. No.: US 2022/0145024 A1
(43) Pub. Date: May 12, 2022

(54) Heat-Shrinkable Polyethylene Films

(71) Applicant: ExxonMobil Chemical Patents Inc., Baytown, TX (US)

(72) Inventors: Pieter-Jan GOOSSENS, Machelen (BE); Thomas CUGNON, Perwez (BE)

(21) Appl. No.: 17/593,986

(22) PCT Filed: Apr. 15, 2020
(86) PCT No.: PCT/US2020/028315

§ 371 Date: Sep. 29, 2021

Related U.S. Application Data
(60) Provisional application No. 62/841,504, filed on May 1, 2019.

(51) Int. Cl. C08J 5/18; C08L 23/06

(52) U.S. Cl. CPC C08J 5/18; C08L 23/06; C08J 2323/08; C08L 2207/20; C08L 2205/02; C08L 2207/066; C08L 2203/16

(57) ABSTRACT

A heat-shrinkable film comprises at least one layer made from a polymer blend comprising a virgin first polymer composition and at least 20 wt % of a recycled second polymer composition. The first polymer composition comprises at least 50 wt % of a polymer (a1) of ethylene and at least one alpha olefin having 5 to 20 carbon atoms, the polymer (a1) having a density from 0.918 to 0.945 g/cm³, a melt index from 0.1 to 2.5 g/10 min, a melt flow ratio from 25 to 80, a Compositional Distribution Breadth Index of at least 70%, and an averaged Modulus (M) from 20,000 to 60,000 psi. The second polymer composition is different from the first polymer composition, has a melt index (I_{2.16}) from 0.1 to 2.5 g/10 min and comprises at least 30 wt % of an ethylene homopolymer (b1) having a density from 0.910 to 0.940 g/cm³.

### CROSS-REFERENCE TO RELATED APPLICATION

This Application claims the benefit of U.S. Provisional application 62/841504, filed May 1, 2019, entitled “Heat-Shrinkable Polyethylene Films”, the entirety of which is incorporated by reference herein.

### FIELD

This invention relates to heat-shrinkable films made from polyethylene resins.

### BACKGROUND

The term ‘heat-shrinkable film’ or simply ‘shrink film’ refers to a plastic wrapping film which has the characteristic of shrinking when it is heated to near the melting point of the film. These films are commonly manufactured from plastic resins such as polyvinyl chloride (PVC); polypropylene (PP); linear-low density polyethylene (LLDPE); low density polyethylene (LDPE); high density polyethylene (HDPE); copolymers of ethylene and vinyl acetate (EVA); copolymers of ethylene and vinyl alcohols (EVOH); ionomers (e.g. Surlyn™); copolymers of vinylidene chloride (e.g. PVDC, SARAN™); copolymers of ethylene acrylic acid (EAA); polyamides (PA); among others.

End uses of these films include food packaging (for example, oxygen and moisture barrier bags for frozen poultry, primal meat cuts and processed meat and cheese products for preservation of freshness and hygienics) and non-food packaging (for example, ‘overwraps’ for protecting goods against damage, soiling, tampering and pilferage) during transportation, distribution, handling and display. One end use example is found in retail sales where the films are wrapped air-tight around single or multiple items of compact disks, audio/video tapes, computer software boxes, magazines, confectionery, boxed products, single serve bowls, etc. Another end use example is found in wholesale retailing where multiple containers of bottled and canned goods such as beverages, condiments and personal hygiene products are sold in bulk. Yet another example is found in courier shipping where single items of shrink-wrapped sporting goods and household appliances are now safely transported without the need for bulky protective cardboard cartons.

Collation shrink films are a particular type of shrink film. Collation shrink films are films that are wrapped around many packaging units (such as bottles or cans) and shrunk to keep the units within the package together. For example, collation shrink film may be wrapped around a multi-pack of drinks that are placed on a cardboard base and the film is then shrunk around the containers. The wrapping process typically involves a shrink oven or shrink tunnel in which the film is heated to cause the collation shrink wrapping to occur. The shrinking of the plastic film causes it to collapse around the multiple containers and hold them in place.

Special families of polymers, such as metallocene polyethylene (mPE) resins available from ExxonMobil Chemical Company, Houston. Tex. have shown particular promise for shrink film applications. Metallocene PE provides a good balance of operational stability, extended output, versatility with higher alpha olefin (HAO) performance, and resin sourcing simplicity. For example, International Patent Application Publication No. WO 2017/139031 discloses a shrink film comprising a metallocene polyethylene polymer comprising at least 65 wt % ethylene derived units and having a melt index (MI) from about 0.1 g/10 min to about 2.0 g/10 min, a density from about 0.905 g/cm³ to about 0.920 g/cm³ and a melt flow ratio (MFR) from about 25 to about 80, wherein the shrink film has a total shrink of from 100% to 200%, a contracting force of 1.5 N or less and a contracting force of L5 N or less.

As resin costs rise and environmental concerns grow, there is an increasing interest in incorporating recycle resins in polyethylene shrink films. However, today penetration of recycle material in shrink films is limited, mainly due to the negative effect of recycle material on the film properties (shrink, puncture, dart drop, tensile, opticals, quality consistency). Moreover, even when recycle material is used, it is often limited to waste material from the original manufacture of the shrink film. For example, U.S. Pat. No. 5,605,660 discloses a process for the manufacture of a multilayer, cross-linked, heat shrinkable, polyolefin film, the film having at least one inner layer including a thermoplastic polymer sandwiched between two outer layers including a thermoplastic polymer different from the thermoplastic polymer of the inner layer, including the steps of coextruding the polymers into a tape; cross-linking the tape; and converting the cross-linked tape into a heat shrinkable film by orientation; wherein scrap material produced in the manufacture of the heat shrinkable film is incorporated by recycling the film into the coextrusion step in an amount up to 50% by weight of the total film weight.

There remains considerable interest in developing new polyethylene shrink films in which significant amounts of waste resin, other than direct recycle from production of the base film, can be incorporated without substantial reduction in overall film properties.

### SUMMARY

According to the invention, it has now been found that using a particular blend of virgin and recycled polyethylenes, it is possible to produce shrink films with excellent properties even when the amount of recycled resin in the blend is 20% by weight or more.

This, in one aspect, the invention resides in a heat shrinkable film comprising at least one layer made from a polymer blend comprising:

(a) at least 20% by weight, based on the total weight of the polymer blend, of a virgin first polymer composition comprising at least 50% by weight of at least one polymer (a1) of ethylene and at least one alpha olefin having from 5 to 20 carbon atoms, the polymer (a1) having a density from about 0.918 g/cm³ to about 0.945 g/cm³, a melt index (I_{2.16}) from about 0.1 g/10 min to about 2.5 g/10 min, a melt flow ratio (I_{21.6}/I_{2.16}) from about 25 to about 80, a Compositional Distribution Breadth Index (CDBI) as defined herein of at least 70%, and an averaged Modulus (M) as herein defined of from 20,000 to 60,000 psi (pounds per square inch); and

(b) at least 20% by weight, based on the total weight of the polymer blend, of a recycled second polymer composition, the second polymer composition being different from the first polymer composition, having a melt index (I_{2.16}) from about 0.1 g/10 min to about 2.5 g/10 min and comprising at least 30% by weight of at least one ethylene homopolymer (b1) having a density from 0.910 g/cm³ to about 0.940 g/cm³,

wherein the film, when heated to 150° C., has a machine direction shrink of at least 70%.

### BRIEF DESCRIPTION OF THE DRAWINGS

FIG. 1 is a spider chart comparing selected physical properties of a 3-layer heat shrinkable film produced according to Example 1 (containing 30% by weight recycled resin) with the same properties of two commercially available 3-layer heat shrinkable films (made of virgin resins only).

FIG. 2 is a spider chart comparing selected physical properties of the heat shrinkable film of Example 1 with those of a similar film produced according to Example 2 (containing 50% by weight recycled resin).

FIG. 3 is a spider chart comparing selected physical properties of a monolayer heat shrinkable film produced according to Example 3 (using resins blended in-situ in the extruder) with those of a similar film produced according to Example 4 (using pre-compounded resins).

FIG. 4 is a spider chart comparing selected physical properties of the 3-layer heat shrinkable film of Example 1 (using resins blended in-situ in the extruder) with those of a 3-layer film produced according to Example 5 (using pre-compounded resins in the core layer).

### DETAILED DESCRIPTION OF THE EMBODIMENTS

Described herein is a heat shrinkable film comprising at least one layer, referred to herein as the core layer, made from a polymer blend comprising at least 20% by weight of a virgin first polymer composition and at least from 20% by weight of a recycled second polymer composition. For example, the core layer may comprise at least 25% by weight, such as at least 30% by weight, for example at least 35% by weight, such as at least 40% of the recycled second polymer composition and in some embodiments may comprise up to 75% by weight, such as up to 70% by weight, such as up to 65% by weight, or up to 60% by weight of the recycled second polymer composition, typically with the remainder being the virgin first polymer composition. In one preferred embodiment, the core layer comprises from 25% to 60% by weight, based on the total weight of the polymer blend, of the virgin first polymer composition and from 40% to 75% by weight, based on the total weight of the polymer blend, of the recycled second polymer composition.

As used herein, the term ‘virgin first polymer composition’ means a polymer resin or a mixture or blend of two or more polymer resins, wherein none of the resins has previously been formed into an industrial or consumer product. The term ‘recycled second polymer composition’ means a polymer resin or a mixture or blend of two or more polymer resins, which has been reclaimed from a prior industrial or consumer use. As such the recycled polymer composition may include additives conventionally added to polymer resins to assist in their processing, such as for example, slip agents. The term ‘recycled’ does not include the scrap material that may be produced in the manufacture of any of the virgin resins used herein or the heat shrinkable film described herein, although such scrap material can of course be used as an additional component of the final film.

### Virgin First Polymer Composition

The virgin first polymer composition comprises at least 50% by weight, such at least 60% by weight, preferably at least 80% by weight, of at least one polymer (a1) of ethylene and at least one alpha olefin comonomer having from 5 to 20 carbon atoms, more preferably 5 to 10 carbon atoms and most preferably 5 to 8 carbon atoms. In one embodiment, the polymer (a1) is a copolymer of ethylene with up to 15% by weight of 1-hexene. As is well known in the art, in order to obtain a desired melt flow ratio, the molar ratio of ethylene and comonomer can be varied, as can the concentration of the comonomer. Control of the polymerization temperature and pressure can also be employed to assist control of the MI.

The polymer (a1) has a density from about 0.918 g/cm³ to about 0.945 g/cm³, such as from about 0.918 g/cm³ to about 0.945 g/cm³, a melt index (I_{2.16}) from about 0.1 g/10 min to about 2.5 g/10 min, such as from about 0.1 g/10 min to about 1.0 g/10 min, and a melt flow ratio (I_{21.6}/I_{2.16}) from about 25 to about 80, such as from about 30 to about 70 g/10 min.

The polymer (a1) has a Compositional Distribution Breadth Index (CDBI) of at least 70%, such as at least 75%, wherein CDBI is determined as set out in columns 7 and 8 of International Patent Publication WO 93/03093, as well as in Wild et al, J. Poly. Sci., Poly. Phys. Ed., Vol.20, p.441 (1982) and in U.S. Pat. No. 5,008,204, all of which are incorporated by reference herein.

In addition, the polymer (a1) has an averaged 1% secant Modulus (M) of from 20,000 to 60,000 psi (pounds per square inch), wherein M is the sum of the 1% secant Modulus in the machine direction and in the transverse direction divided by two and the 1% secant Modulus is determined in accordance with ASTM D-882-91. In embodiments, the relation between M and the Dart Impact Strength in g/mil (DIS) of the polymer (a1) complies with the formula:

$$DIS ≧ 0.8 \times [ 100 + {e}^{( 11.71 - 0.000268 \times M + 2.183 \times {10}^{- 9} \times {M}^{2} )} ]$$

where “e” is the base Napierian logarithm, M is the averaged modulus in psi and the DIS is determined in accordance with ASTM D1709-91 (26 inch). Typical values for DIS are from 120 to 1000 g/mil, especially less than 800 and more than 150 g/mil.

The polymer (a1) is obtainable by a continuous gas phase polymerization using a supported metallocene catalyst in the substantial absence of an aluminum alkyl based scavenger (e.g., triethylaluminum (TEAL), trimethylaluminum (TMAL), triisobutyl aluminum (TIBAL), tri-n-hexylaluminum (TNHAL) and the like). The catalyst may comprise at least one bridged bis-cyclopentadienyl transition metal complex and an alumoxane activator on a common or separate porous support, such as silica, with the catalyst being homogeneously distributed in the silica pores. More details of the production of the polymer (a1) can be found in U.S. Pat. No. 6,255,426, the entire contents of which are incorporated herein by reference.

Commercially available examples of the polymer (a1) include the Enable™ resins supplied by ExxonMobil Chemical, such as Enable™ 4002MC (with a density of 0.940 and a MI of 0.25 g/10 min) and Enable™ 2703HH (with a density of 0.927 g/cm³ and a MI of 0.3 g/10 min).

In addition to the polymer (a1), the virgin first polymer composition may also comprise up to 20% by weight, such as up to 15% by weight, for example up to 10% by weight, typically from 1% to 10% by weight, of at least one virgin high density ethylene polymer (a2). Suitable HDPE materials have a melt index (1₂₁₆) from about 0.1 g/10 min to about 2.5 g/10 min, such as from 0.1 to 1 g/10 min, and a density from about 0.941 g/cm³ to about 0.965 g/cm³, such as from about 0.955 g/cm³ to about 0.965 g/cm³. A suitable commercially available example of the polymer (a2) includes the homopolymer polyethylene resin supplied by ExxonMobil Chemical as HDPE HTA 108 (with a density of 0.961 g/cm³ and a MI of 0.7 g/10 min).

The virgin first polymer composition may also comprise up to 20% by weight, such as up to 15% by weight, for example up to 10% by weight, typically from 1% to 10% by weight, of at least one low density ethylene polymer (a3) different from the polymer (a1). Suitable LDPE polymers (a3) have a melt index (I_{2.16}) from about 0.1 g/10 min to about 2.5 g/10 min, such as from 0.1 to 1 g/10 min, and a density from greater than 0.910 g/cm³ to about 0.930 g/cm³, such as 0.915 g/cm³ to about 0.925 g/cm³. A suitable commercially available example of the polymer (a3) includes the polyethylene resin supplied by ExxonMobil Chemical as LDPE LD 165BW1 (with a density of 0.922 g/cm³ and a MI of 0.33 g/10 min).

### Recycled Second Polymer Composition

The recycled second polymer composition employed in the core layer of the present shrinkable film is different from the first polymer composition and has a melt index (1₂₁₆) from about 0.1 g/10 min to about 2.5 g/10 min, such as from about 0.1 g/10 min to about 1.0 g/10 min. The recycled second polymer composition comprises at least 30% by weight, such as at least 40% by weight, and up to 90% by weight, or even 100% by weight, preferably 50 to 85% by weight, of at least one ethylene homopolymer (b1) having a density from 0.910 g/cm³ to about 0.940 g/cm³. Such a homopolymer is generally referred to as low density polyethylene or LDPE and is produced by high pressure polymerization. LDPE has extensive long chain branching (typically from 0.5 to 5 long chain branches per 1000 carbon atoms).

In addition to the LDPE component (b1), the recycled second polymer composition may also comprise at least 10% by weight, such as at least 20% by weight, and up to 60% by weight, such as up to 70% by weight, preferably 20 to 65% by weight, of at least one linear low density copolymer (b2) of ethylene and at least one alpha olefin having from 5 to 20 carbon atoms, the polymer (b2) having a density from 0.910 g/cm³ to about 0.940 g/cm³. Such a copolymer is generally referred to as LLDPE and is produced by catalyzed low pressure polymerization. LLDPE has little or no long chain branching (typically less than 0.1 long chain branches per 1000 carbon atoms for LLDPE produced using metallocene catalysts).

A suitable commercially available example of the recycled second polymer composition comprises the material supplied by the Ravago Group as Ravalene® CR LS 5241, which has a specified low density polyethylene (LDPE) content of at least 80 wt % and a linear low density polyethylene (LLDPE) content of up to 20 wt %. It can contains up to 2% of polypropylene (PP) and traces (i.e. <0.5%) of other polymers, such as ethyl vinyl alcohol (EVA), as well as processing additives, such as slip agents. Typical values melt index (MI) and density values for Ravalene® CR LS 5241 are 1.3 g/10 min (tested at 2.16 kg and 190° C.) and 0.925 g/cm³, respectively.

Heat Shrinkable Film

The heat shrinkable film described herein may be a single layer film, in which case the core layer consists of the entire film. Alternatively, the film may comprise two or more layers, in which the core layer is provided on at least one major surface, or more normally both major surfaces, with one or more skin layers. Preferred multilayer films comprise three layers, with a skin layer on each major surface of the core layer, and five layers, with two skin layers on each major surface of the core layer. The skin layers may be the same as or different from each other. Preferably, the skin layers are different from the core layer and in particular may be free of added recycled polymer. Suitable materials for use as the skin layers in the present film are the metallocene-catalyzed polyethylene resins supplied by ExxonMobil Chemical under the Exceed and Exceed XP tradenames, for example Exceed™ 1018HA and Exceed™ XP8784, either alone or in combination with a HDPE resin (having a density from 0.941 g/cm³ to about 0.965 g/cm³) or an LDPE resin.

The heat shrinkable film described herein may be produced by blowing or casting using conventional extrusion techniques. In forming the core layer, the virgin and recycled polymer compositions may be pre-blended by melt-compounding before being fed to the extruder or the different resin materials may be fed separately to the extruder.

Typically, the heat shrinkable film described herein comprises at least 20% by weight and up to 60% by weight, such as from 30 to 50% by weight, of the recycled polymer composition based on the total weight of the film. Even with the presence of such large quantities of recycle, the film, when heated to 150° C., has a machine direction shrink of at least 70% and preferably a transverse direction shrink of at least 15%.

The invention will now be more particularly described with reference to the following non-limiting Examples and the accompanying drawings.

In the Examples and the preceding discussion, the following standard tests and modified standard tests are employed to measure the various resin and film properties reported:

Density is measured in accordance with ASTM D-1505.

Melt dex is measured in accordance with ASTM D-1238.

Haze % is measured in accordance with ASTM D-1003.

1% secant Modulus is measured in accordance with ASTM D-882-91.

Elmendorf tear strength is measured in accordance with ASTM D1922-15.

Tensile strength at break: is measured in accordance with a test based on ASTM D882-18 with a gauge length of 50 mm being used for all specimens and the initial grip separation always being set to 50 mm

Needle Puncture Resistance is measured in accordance with a test based on CEN144777-2004 with specimens being conditioned at 23±2° C. and 50±10% RH for 40 hours before testing.

Gloss 45° is measured in accordance with a test based on ASTM D-2457-13 in which a background with dark green abrasive paper is always used as sample holder and readings are only performed in MD direction with the result reported as the mean value of five specimens.

Holding Force (N) is measured in accordance with ISO 14616 using a Retratech Shrink Force Tester.

Clarity is measured in accordance with a test based on ASTM D-1746 with readings only being performed in the MD direction.

Dart Impact is measured by a method following ASTM D-1709-04 on a Dart Impact Tester Model C from Davenport Lloyd Instruments in which a pneumatically operated annular clamp is used to obtain a uniform flat specimen and the dart is automatically released by an electro-magnet as soon a sufficient air pressure is reached on the annular clamp. The test measures energy in terms of the weight (mass) of the dart falling from a specified height, which would result in 50% failure of specimens tested. Method A used darts head made of Tuflon™ (a phenolic resin) with a diameter of 38mm dropped from a height of 660 mm for films whose impact resistance requires masses of 50 g or less to 2 kg to fracture them. Method B employs a dart with a diameter of 51 mm dropped from a height of 1524 mm with an internal diameter of the specimen holder of 127 mm for both method A and B. The values given are acquired by the standard Staircase Testing Technique. The samples have a minimum width of 20 cm and a recommended length of 10 m and should be free of pinholes, wrinkles, folds, or other obvious imperfections.

Shrink (Betex shrink), reported as a percentage, is measured by cutting circular specimens from a film sample using a 50 mm die after allowing the film sample to condition for at least 40 hours at 23±2° C. and 50±10% relative humidity. The samples are then put on a brass foil and embedded in a layer of silicon oil. This assembly is heated by putting it on a 150° C. hot plate (model Betex) until the dimensional change ceases. An average of the shrinkage obtained with six specimens is reported.

### EXAMPLE 1

A three layer co-extruded heat sealable film was produced on a Windmoeller & Hoelscher (W&H) coextrusion line with a die gap of 1.4 mm, a blow-up ratio (BUR) of 3.2 and an output of approximately 225 kg/h. The processing temperature was 200-210° C. and total thickness of the film was 40 μm, with a relative layer thickness of 1 (skin): 3 (core): 1 (skin). The composition of the film was as follows:
Core layer: 50 wt % Ravalene™ CR LS 5241
   40 wt % Enable™ 4002MC
   5 wt % HDPE HTA 108
   5 wt % LDPE LD 165BW1
Skin layers: 90 wt % Exceed™ 1018HA
   10 wt % HDPE HTA 108

The recycled resin used in the core layer was in-situ blended with the virgin resins employed in the core layer during the blowing process. The recycled resin made up 30% by weight of the total film.

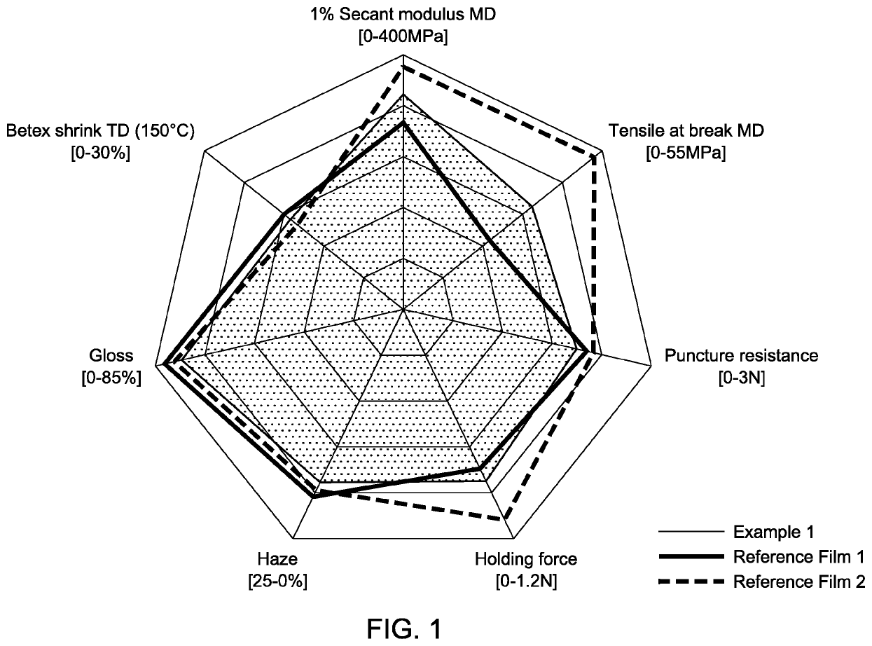

The properties of the resultant film were tested and the results are summarized in Table 1 and FIG. 1 (grey area). Also summarized in Table 1 and FIG. 1 are the physical properties of two three-layer reference films, each produced at a BUR of 3.2, a total thickness of 40 μm and layer distribution of 1:3:1. The compositions of the references films, which were produced using only virgin resins, are as follows:

### Reference Film 1 (Shown by Solid Line in FIG. 1)

Core layer: 80 wt % ExxonMobil™ LDPE LD 159AC
   20 wt % HDPE HTA 108
Skin layers: 95 wt % ExxonMobil™ LLDPE LL 1001XV
   5 wt % LDPE LD 165BW1

### Reference Film 2 (Shown by Dashed Line in FIG. 1)

Core layer: 70 wt % Enable™ 4002MC
   20 wt % HDPE HTA 108
   10 wt % LDPE LD 159AC
Skin layers: 90 wt % Exceed™ 1018HA
   10 wt % HDPE HTA 108

It will be seen from FIG. 1 and Table 1 that, for all critical shrink film properties, the film of Example 1 is at least on par with the Reference Film 1, although exhibits somewhat reduced secant modulus, tensile strength and holding force as compared with Reference Film 2.

### EXAMPLE 2

The film of Example 1 was reproduced but with the amount of Ravalene™ CR LS 5241 in the core layer being increased to 70 wt %, the amount of Enable™ 4002MC being reduced to 20 wt % and the layer distribution being 1:5:1. All other parameters remained the same.

The recycled resin made up 50% by weight of the total film.

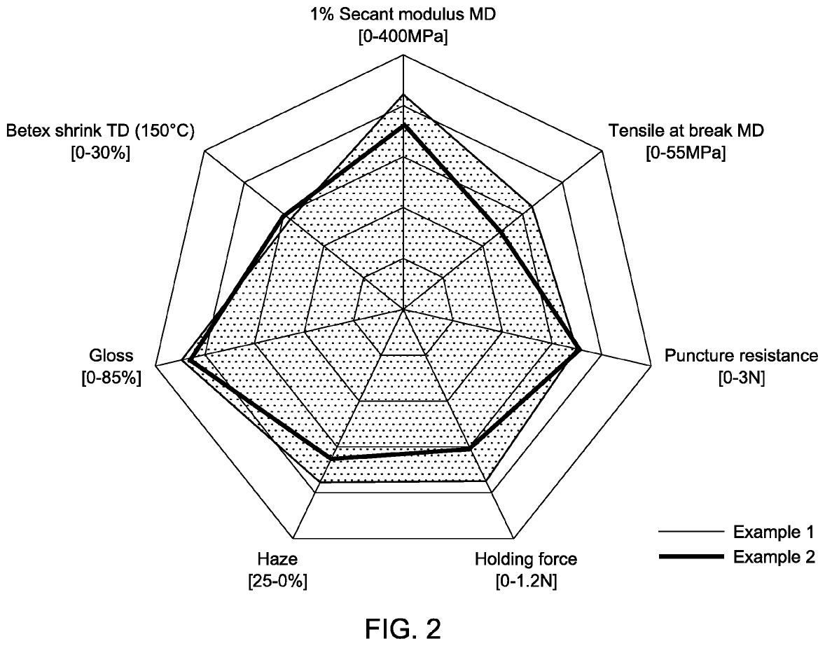

The properties of the resultant film were tested and are summarized in Table 1. The test results are compared with those of the film of Example 1 in FIG. 2, in which the grey area indicates the properties of the film of Example 1 and the solid line indicates the properties of the film of Example 2. It will be seen that the properties of the film of Example 2 are very similar to those of the film of Example 1 (despite the increased amount of recycle resin), with small reductions in secant modulus, tensile strength and holding force, and a slight increase in haze.

TABLE 1

| | | Reference | Reference | |
|---|---|---|---|---|
| | Example 1 | Film 1 | Film 2 | Example 2 |
| 1% Secant modulus MD | 340 | 294 | 381 | 291 |
| (MPa) | | | | |
| Tensile at break MD | 35.8 | 24.1 | 52.9 | 26.5 |
| (MPa) | | | | |
| Puncture resistance (N) | 2.10 | 2.22 | 2.30 | 2.12 |
| Holding force (N) | 0.898 | 0.833 | 1.097 | 0.722 |
| Haze (%) | 6.0 | 4.6 | 5.3 | 8.7 |
| Gloss (%) | 76.7 | 81.5 | 78.5 | 73.5 |
| Betex shrink TD (%) | 17 | 18 | 16 | 18 |

### EXAMPLES 3 and 4

Monolayer shrink films at a BUR of 3.0 and a thickness of 50 μm were produced on a Hosokawa Alpine-2 monolayer blowing line with a die gap of 1.5 mm and an output of approximately 120 kg/h. The processing temperature for producing the monolayer films was set to 250° C. to ensure optimal melting and to avoid melt fracture originating from the recycle/virgin polymer blends. In the case of Example 3, the resin materials from the core layer in Example 1 (namely 50 wt % Ravalene CR LS 5241+40 wt % Enable 4002MC +5 wt % HDPE HTA 108+5 wt % LDPE LD 165BW I) were fed separately to the different hoppers of the film blowing line's single extruder. In the case of Example 4, the blend employed was a pre-compounded resin with the same composition as Example 3, this time only fed to the main hopper of the extruder.

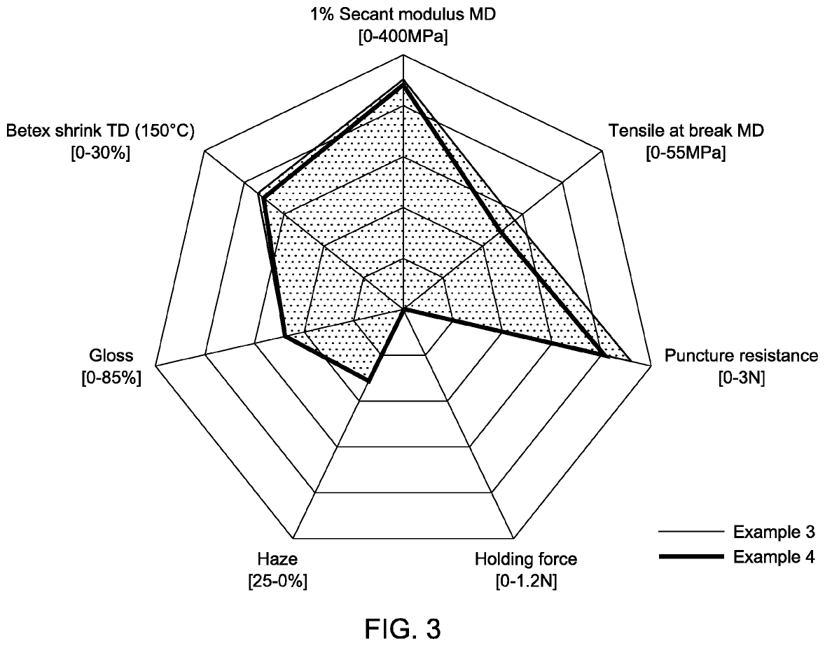

The properties of the resulting films are summarized in Table 2 and FIG. 3 (with the grey area in FIG. 3 representing the film of Example 3 and the solid line the film of Example 4). Although the pre-compounding step was expected to homogenize the final product and to improve and maintain consistency of mechanical film properties, it will be seen that no significant difference in film properties between the in-situ blend and pre-compounded solution was observed. This may be at least partly explained by the fact that in the test pre-compounding was done by blending virgin pellets with recycle pellets, without adding antioxidants, and by using a heavy shear-inducing twin screw extruder without proper melt filtration and without degassing. If the pre-compounding step is conducted in a single step (i.e. blending virgin pellets with flakes of film waste), while adding the right types and amounts of antioxidants, and by using state-of-the-art extrusion technologies with melt filtration systems and online degassing of volatiles, it is possible that an improvement of the respective film properties vs an in-situ blend would be evident.

### EXAMPLE 5

A three-layer shrink film was produced using the process and composition of Example 1 but with the resin materials of the core layer being pre-compounded prior to the film blowing process. The properties of the resultant film are compared with those of Example 1 in

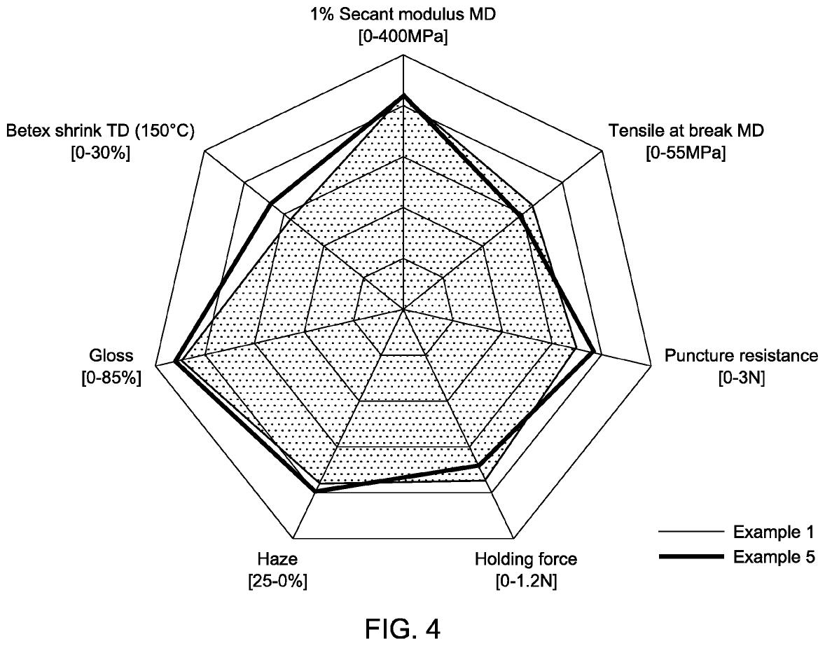

Table 2 and FIG. 4 (with the grey area in FIG. 4 representing the film of Example 1 and the solid line the film of Example 5). Again no significant difference in film properties between the in-situ blend and pre-compounded solution was observed.

TABLE 2

| | Example 3 | Example 4 | Example 1 | Example 5 |
|---|---|---|---|---|
| 1% Secant modulus MD | 363 | 353 | 340 | 336 |
| (MPa) | | | | |
| Tensile at break MD | 30.6 | 26 | 35.8 | 32.4 |
| (MPa) | | | | |
| Puncture resistance (N) | 2.74 | 2.43 | 2.10 | 2.29 |
| Holding force (N) | n/a | n/a | 0.898 | 0.820 |
| Haze (%) | 17.4 | 17.1 | 6.0 | 5.2 |
| Gloss (%) | 39.5 | 40.4 | 76.7 | 78.6 |
| Betex shrink TD (%) | 22 | 21 | 17 | 20 |

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A heat-shrinkable film comprising at least one layer made from a polymer blend comprising:
(a) at least 20% by weight, based on the total weight of the polymer blend, of a virgin first polymer composition comprising at least 50% by weight of at least one polymer (a1) of ethylene and at least one alpha olefin having from 5 to 20 carbon atoms, the polymer (a1) having a density from about 0.918 g/cm³ to about 0.945 g/cm³, a melt index (I_{2.16}) from about 0.1 g/10 min to about 2.5 g/10 min, a melt flow ratio (I_{21.6}/I_{2.16}) from about 25 to about 80, a Compositional Distribution Breadth Index (CDBI) as defined herein of at least 70%, and an averaged Modulus (M) as herein defined of from 20,000 to 60,000 psi; and
(b) at least 20% by weight, based on the total weight of the polymer blend, of a recycled second polymer composition, the second polymer composition being different from the first polymer composition, having a melt index (I_{2.16}) from about 0.1 g/10 min to about 2.5 g/10 min and comprising at least 30% by weight of at least one ethylene homopolymer (1) having a density from 0.910 g/cm³ to about 0.940 g/cm³,
wherein the film, when heated to 150° C., has a machine direction shrink of at least 70%.

2. The film of claim 1, wherein the ethylene polymer (a1) has a relation between M and the Dart Impact Strength in g/mil (DIS) complying with the formula:
$$DIS ≧ 0.8 \times [ 100 + {e}^{( 11.71 - 0.000268 \times M + 2.183 \times {10}^{- 9} \times {M}^{2} )} ]$$

3. The film of claim 1, wherein the ethylene polymer (a1) is produced using a metallocene catalyst.

4. The film of claim 1, wherein the virgin first polymer composition comprises at least 60% by weight, preferably at least 80% by weight, of the ethylene polymer (a1).

5. The film of claim 1, wherein the virgin first polymer composition further comprises up to 20% by weight of at least one ethylene polymer (a2) having a melt index (I_{2.16}) from about 0.1 g/10 min to about 2.5 g/10 min and density from 0.941 g/cm³ to about 0.965 g/cm³.

6. The film of claim 5, wherein the virgin first polymer composition further comprises from 1% to 10% by weight of the ethylene polymer (a2).

7. The film of claim 1, wherein the virgin first polymer composition further comprises up to 20% by weight of at least one ethylene polymer (a3) different from the polymer (a1) and having a melt index (I_{2.16}) from about 0.1 g/10 min to about 2.5 g/10 min and a density from greater than 0.910 g/cm³ to about 0.930 g/cm³.

8. The film of claim 7, wherein the virgin first polymer composition comprises from 1% to 10% by weight of the at least one ethylene polymer (a3).

9. The film of claim 1, wherein the second polymer composition comprises at least 50% by weight of the ethylene polymer (b 1).

10. The film of claim 1, wherein the second polymer composition further comprises up to 70% by weight of at least one polymer (b2) of ethylene and at least one alpha olefin having from 5 to 20 carbon atoms, the polymer (b2) having a melt index (I_{2.16}) from about 0.1 g/10 min to about 2.5 g/10 min and a density from 0.910 g/cm³ to about 0.940 g/cm³.

11. The film of claim 1, wherein the second polymer composition further comprises at least one slip agent.

12. The film of claim 1, wherein said one layer comprises from 25% to 60% by weight, based on the total weight of the polymer blend, of the virgin first polymer composition and from 40% to 75% by weight, based on the total weight of the polymer blend, of the recycled second polymer composition.

13. The film of claim 1, wherein the first and second polymer compositions polymer are melt compounded to produce the polymer blend prior to extrusion of the blend into the film.

14. The film of claim 1, wherein the first and second polymer compositions polymer are separately fed to extruders to produce the polymer blend during formation of the film.

15. The film of claim 1, having a transverse direction shrink of at least 15% when heated to 150° C.

16. The film of claim 1 composed of a single layer made from the polymer blend.

17. The film of claim 1, comprising a core layer made from the polymer blend and at least one skin layer on each surface of the core layer.
